(19) United States
(12) Patent Application Publication
(10) Pub. No.: US 2008/0274706 A1
(43) Pub. Date: Nov. 6, 2008

(54) Techniques for antenna retuning utilizing transmit power information

(76) Inventor: Guillaume Blin, Malden, MA (US)

Correspondence Address: LAW OFFICE OF WILLIAM J. TUCKER, 2631 Lakeforest Ct., Dallas, TX, 75214, US

(21) Appl. No.: 11/799,242

(22) Filed: May 1, 2007

(51) Int. Cl. H04B 1/40

(52) U.S. Cl. 455/84

(57) ABSTRACT

An embodiment of the present invention provides a radio frequency (RF) transceiver, comprising a transmitter, a receiver, an antenna connected to the transmitter and the receiver via a tuner, a power detector adapted to acquire information about transmit power, and wherein the tuner tunes the antenna based upon the transmit information to optimize the antenna in both the receive and transmit bands.

### BACKGROUND OF THE INVENTION

Wireless devices have become prevalent throughout society. As users demand more mobility, there is a tremendous requirement for decreasing power consumption and thereby increasing battery life. Further, many wireless devices may transmit on a plurality of carrier frequencies and include circuits dealing with several frequency bands of operation and may receive and transmit at varying power levels. In wireless applications, the transmitted power is much higher than the received power and to perform the retuning of a mismatched antenna or matching network, power measurement must be performed.

Thus, there is a strong need for techniques for antenna retuning utilizing transmit power information.

### SUMMARY OF THE INVENTION

An embodiment of the present invention provides an apparatus, comprising a transmitter, a tunable antenna associated with the transmitter, a power detector adapted to acquire information about transmit power, and wherein the tunable antenna is tuned based upon the transmit measurements to optimize the antenna in both the receive and transmit bands.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates a first apparatus adapted for closed loop transmit power measurements and antenna retuning of an embodiment of the present invention;

FIG. 2 illustrates a second apparatus adapted for closed loop transmit power measurements and antenna retuning of an embodiment of the present invention;

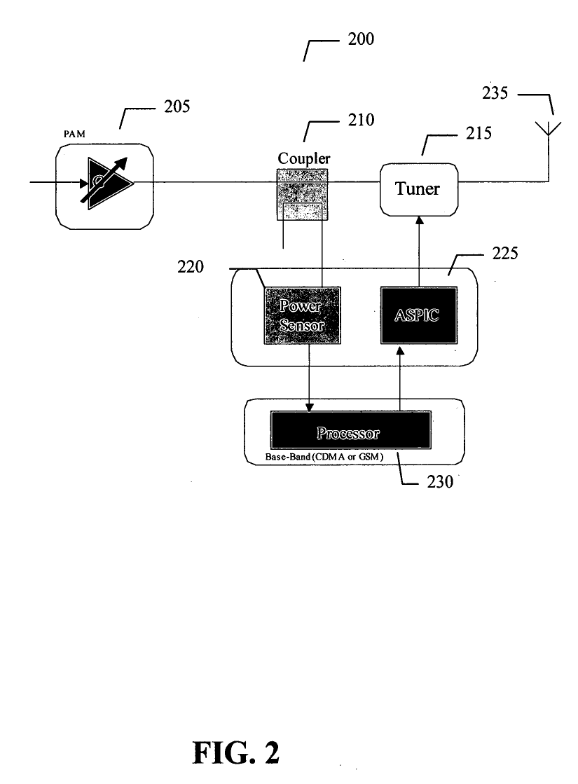

FIG. 3 illustrates a method according to one embodiment of the present invention.

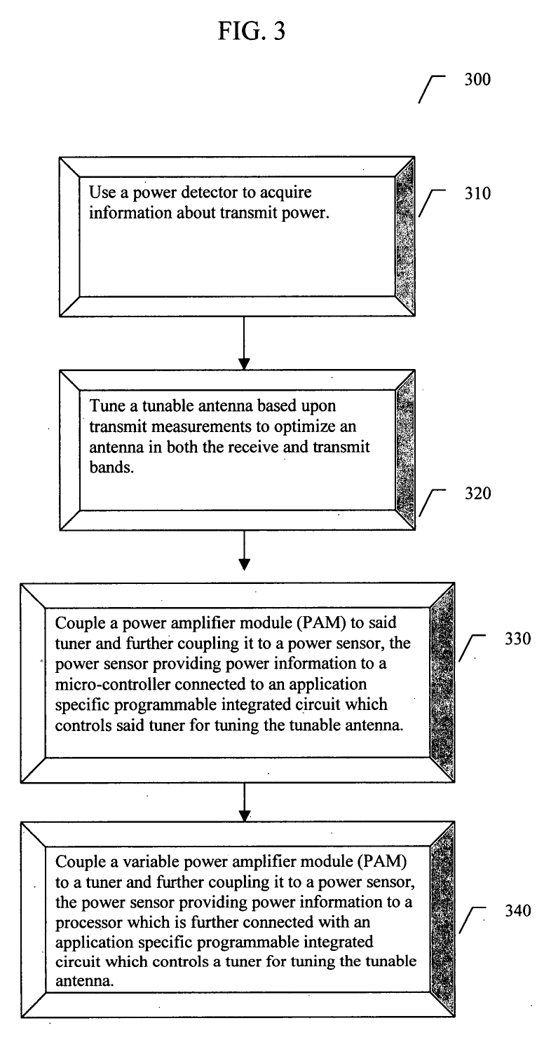

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm is here, and generally, considered to be a self-consistent sequence of acts or operations leading to a desired result. -These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

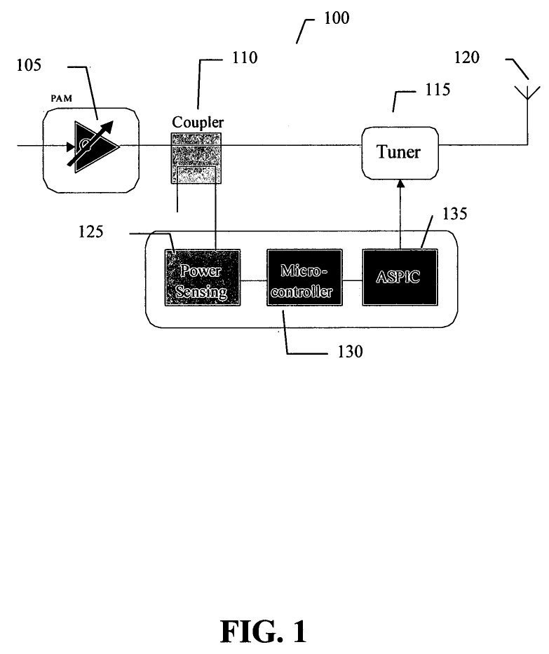

Looking now at FIG. 1 is an embodiment of the present invention which provides an apparatus, comprising a transmitter 100, a tuner 115 capable of tuning antenna 120 associated with the transmitter 100, a power detector 125 adapted to acquire information about transmit power, and wherein the tuner 115 tunes the antenna 120 based upon the transmit measurements to optimize the antenna 120 in both the receive and transmit bands.

An embodiment of the present invention may further comprise the apparatus further comprising a power amplifier module (PAM) 105 coupled via a coupler 110 to a tuner 115 and further coupled to a power sensor 125, the power sensor 125 may provide power information to a micro-controller 130 connected to an application specific programmable integrated circuit (ASPIC) 135 which controls the tuner 115 for tuning the tunable antenna 120.

Still another embodiment of the present invention provides the apparatus further comprising a variable power amplifier module (PAM) 205 coupled via a coupler 210 to a tuner 215 and further coupled to a power sensor 220, the power sensor 220 providing power information to a processor 230 which may be further connected with an application specific programmable integrated circuit (ASPIC) 225 which controls the tuner 215 for tuning the tunable antenna 235. In any of the present embodiments, and not limited it this respect, the antenna tuner may be tuned by using voltage tunable dielectric capacitors.

In an embodiment of the present invention the PAM may have a power controller measuring the output power and if the PAM has a power controller measuring the output power (directive coupler), the control of the PAM may adjust antenna impedance matching module (AIMM) output power, assuming an algorithm that may be used for the present invention has converged. If there is no power feedback within the PAM, the AIMM will change a wireless mobile handset (that may incorporate some embodiments of the present invention) output power. Further, the handset may transmit to a base station associated with the handset the RSSI information for network power management. The output power change due to the retuning of the antenna can be seen as a change of environment by the network

Yet another embodiment of the present invention provides a method, comprising using a power detector to acquire information about transmit power 310 and tuning a tunable antenna based upon transmit measurements to optimize an antenna in both the receive and transmit bands 320. An embodiment of the present method may further comprise coupling a power amplifier module (PAM) to the tuner and further coupling it to a power sensor, the power sensor providing power information to a micro-controller connected to an application specific programmable integrated circuit which controls the tuner for tuning the tunable antenna 330. Also, the present embodiment may further comprise coupling a variable power amplifier module (PAM) to a tuner and further coupling it to a power sensor, the power sensor providing power information to a processor which is further connected with an application specific programmable integrated circuit which controls a tuner for tuning the tunable antenna 340.

Some embodiments of the present invention may be implemented, for example, using a machine-readable medium or article which may store an instruction or a set of instructions that, if executed by a machine, for example, by the microcontroller 130 or ASPIC 135 of FIG. 1, or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

In an embodiment of the present invention the machine-accessible medium that provides instructions, which when accessed, may cause the machine to perform operations comprising using a power detector to acquire information about transmit power; and tuning a tunable antenna based upon transmit measurements to optimize an antenna in both the receive and transmit bands. The machine-accessible medium of the present invention may further comprise the instructions causing the machine to perform operations further comprising coupling a power amplifier module (PAM) to the tuner and further coupling it to a power sensor, the power sensor providing power information to a micro-controller connected to an application specific programmable integrated circuit which controls the tuner for tuning the tunable antenna The machine-accessible medium may also comprise the instructions causing the machine to perform operations further comprising coupling a variable power amplifier module (PAM) to a tuner and further coupling it to a power sensor, the power sensor providing power information to a processor which is further connected with an application specific programmable integrated circuit which controls a tuner for tuning the tunable antenna.

Some embodiments of the present invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

In yet another embodiment of the present invention is provided a radio frequency (RF) transceiver, comprising a transmitter, a receiver, an antenna connected to the transmitter and the receiver via a tuner, a power detector adapted to acquire information about transmit power, and wherein the tuner tunes the antenna based upon the transmit information to optimize the antenna in both the receive and transmit bands.

The RF transceiver may further comprise a power amplifier module (PAM) coupled to the tuner and further coupled to a power sensor, the power sensor providing power information to a micro-controller connected to an application specific programmable integrated circuit which controls the tuner for tuning the tunable antenna.

Also, the RF transceiver may further comprise a variable power amplifier module (PAM) coupled to the tuner and further coupled to a power sensor, the power sensor providing power information to a processor which is further connected with an application specific programmable integrated circuit which controls the tuner for tuning the tunable antenna

Regarding the timing for retuning, in an embodiment of the present invention the antenna retuning may occur once per frame, before the burst. In this case, power is measured and averaged on the previous burst and the calculation of next biasing points is performed and new values are applied for the following burst. This has the advantages of a lot of time to compute, power savings, no transients issues (spurious) and is fast enough for humans (−100 ms for retuning).

While the present invention has been described in terms of what are at present believed to be its preferred embodiments, those skilled in the art will recognize that various modifications to the disclose embodiments can be made without departing from the scope of the invention as defined by the following claims.

What is claimed is:

1. An apparatus, comprising:
a transmitter;
a tunable antenna associated with said transmitter;
a power detector adapted to acquire information about transmit power;
and wherein said tunable antenna is tuned based upon said transmit measurements to optimize said antenna in both the receive and transmit bands.

2. The apparatus of claim 1, wherein said apparatus further comprises a power amplifier module (PAM) coupled to a tuner and further coupled to a power sensor, said power sensor providing power information to a micro-controller connected to an application specific programmable integrated circuit which controls said tuner for tuning said tunable antenna.

3. The apparatus of claim 1, wherein said receiver further comprises a variable power amplifier module (PAM) coupled to a tuner and further coupled to a power sensor, said power sensor providing power information to a processor which is further connected with an application specific programmable integrated circuit which controls a tuner for tuning said tunable antenna.

4. The apparatus of claim 1, wherein said antenna tuner is tuned by using voltage tunable dielectric capacitors.

5. A method, comprising:
using a power detector to acquire information about transmit power; and
tuning a tunable antenna based upon transmit measurements to optimize an antenna in both the receive and transmit bands.

6. The method of claim 5, further comprising coupling a power amplifier module (PAM) to said tuner and further coupling it to a power sensor, said power sensor providing power information to a micro-controller connected to an application specific programmable integrated circuit which controls said tuner for tuning said tunable antenna.

7. The method of claim 5, further comprising coupling a variable power amplifier module (PAM) to a tuner and further coupling it to a power sensor, said power sensor providing power information to a processor which is further connected with an application specific programmable integrated circuit which controls a tuner for tuning said tunable antenna.

8. The method of claim 5, further comprising tuning said antenna tuner by using voltage tunable dielectric capacitors.

9. A machine-accessible medium that provides instructions, which when accessed, cause a machine to perform operations comprising:
using a power detector to acquire information about transmit power; and
tuning a tunable antenna based upon transmit measurements to optimize an antenna in both the receive and transmit bands.

10. The machine-accessible medium of claim 9, further comprising said instructions causing said machine to perform operations further comprising coupling a power amplifier module (PAM) to said tuner and further coupling it to a power sensor, said power sensor providing power information to a micro-controller connected to an application specific programmable integrated circuit which controls said tuner for tuning said tunable antenna.

11. The machine-accessible medium of claim 9, further comprising said instructions causing said machine to perform operations further comprising coupling a variable power amplifier module (PAM) to a tuner and further coupling it to a power sensor, said power sensor providing power information to a processor which is further connected with an application specific programmable integrated circuit which controls a tuner for tuning said tunable antenna.

12. The machine-accessible medium of claim 9, further comprising said instructions causing said machine to perform operations further comprising tuning said antenna tuner by using voltage tunable dielectric capacitors.

13. A radio frequency (RF) transceiver, comprising:
a transmitter;
a receiver;
an antenna connected to said transmitter and said receiver via a tuner;
a power detector adapted to acquire information about transmit power; and wherein said tuner tunes said antenna based upon said transmit information to optimize said antenna in both the receive and transmit bands.

14. The RF transceiver of claim 13, further comprising a power amplifier module (PAM) coupled to said tuner and further coupled to a power sensor, said power sensor providing power information to a micro-controller connected to an application specific programmable integrated circuit which controls said tuner for tuning said tunable antenna.

15. The RF transceiver of claim 13, wherein said receiver further comprises a variable power amplifier module (PAM) coupled to said tuner and further coupled to a power sensor, said power sensor providing power information to a processor which is further connected with an application specific programmable integrated circuit which controls said tuner for tuning said tunable antenna.

16. The RF transceiver of claim 13, wherein said antenna tuner is tuned by using voltage tunable dielectric capacitors.
